(19) United States
(12) Patent Application Publication
(10) Pub. No.: US 2002/0013722 A1
(43) Pub. Date: Jan. 31, 2002

(54) Enhanced document escrow service

(76) Inventor: Samantha J. Kanaga, Centreville, VA (US)

Correspondence Address: Richard C. Litman, LITMAN LAW OFFICES, LTD., P.O. Box 15035, Arlington, VA, 22215, US

(21) Appl. No.: 09/839,238

(22) Filed: Apr. 23, 2001

Related U.S. Application Data
(60) Provisional application No. 60/221,186, filed on Jul. 27, 2000.

(51) Int. Cl. G06F 17/60

(52) U.S. Cl. 705/8

(57) ABSTRACT

A method and system where a trusted third party handles an escrow transaction between two or more parties according to specific instructions. The method involves one person (an initiator) transmitting a document set to a trusted third party, along with a list of designated recipients and detailed document-processing instructions. Termination of the instructions occur when conditions set by the initiator have been met or a specified end date has been met. Compliance with these instructions defines the end of the transaction. Optionally, the initiator may specify a protocol for notifying all parties of the outcome of the transaction. Optionally, process start dates and decision dates may be set. The system used may include basic input and output peripherals, the Internet or other public communication system and a trusted third party web site.

### CROSS-REFERENCE TO RELATED APPLICATION

This application claims the benefit of U.S. Provisional Patent Application Ser. No. 60/221,186, filed Jul. 27, 2000.

### BACKGROUND OF THE INVENTION

1. Field of the Invention

The present invention relates to an enhanced method and system to escrow and process transacting documents according to specific instructions. The process may involve two or more parties.

2. Description of Related Art

The usage of globally networked computers is radically changing the way that people around the world do business. The largest computer network, the Internet, has virtually eliminated geographic barriers to business collaborations and thus facilitated the development of entirely new ways of doing business. The Internet has made it easier to place orders, sell merchandise, gain access to research materials, communicate efficiently with clients and colleagues and even telecommute to work from one's own home. In essence, geographic distance is no longer an obstacle to doing business.

U.S. Pat. No. 4,951,196 issued to Jackson outlines the use of electronic data interchange (EDI) among a variety of parties or trading partners. The programmable machine is programmed to define, enter and translate business transaction data in a variety of different dictionary-structured formats. This enables a user to have the flexibility to work with EDI electronic data in various formats without reprogramming the programmable machine.

U.S. Pat. No. 5,329,589 issued to Fraser et al. outlines a general technique by which a communications system may mediate many types of transactions involving entities reachable by the communications system. This patent specifically discloses an embodiment of this in an example of a telephone system and how to use a communications system to mediate an ordinary credit card transaction.

U.S. Pat. No. 5,495,412 issued to Thiessen outlines a computer-based method and apparatus for interactive computer-assisted negotiations assisting multiple parties involved in complex multiple issues which optimize the individual and overall benefit to the parties. The computer-based method and apparatus uses standard mixed integer linear programming techniques to accomplish this.

U.S. Pat. No. 5,790,677 issued to Fox et al. outlines an electronic commerce system that facilitates secure electronic commerce transactions among multiple participants. The electronic commerce system has a credential binding server at a trusted credential authority, multiple computing units at associated participants and a communications system interconnecting the credential binding server and the multiple computing units.

U.S. Pat. No. 5,826,244 issued to Huberman outline the use of a system and method to enable and facilitate networked, automated, brokered auctioning of document services. Document services include printing, copying, scanning, text and image recognition, binding and other related processes. The brokered auctioning of these services make the market more efficient and result in optimal resource allocation and pricing.

U.S. Pat. No. 5,842,178 issued to Giovannoli outlines the use of a computerized system forming a computer based communications network for processing requests for quotation for goods and services by broadcasting such requests to network members of the computerized system over any conventional transmitting medium (such as the Internet) to which the computerized system may be connected. There is no central pricing database to limit the number buyers and vendors of goods and services which can be processed.

One idea or concept that is not reflected in the related art is the use of an escrow or third party to facilitate the commencement of agreements under the control of a trusted third party. The trusted third party can facilitate business between two parties or more that do not have a confidence or trust in each other to do so alone. A trusted third party could facilitate other transactions or agreements that might not otherwise come to commencement.

None of the above inventions and patents, taken either singly or in combination, is seen to describe the instant invention as claimed.

### SUMMARY OF THE INVENTION

The invention is a method and system where a trusted third party handles an escrow transaction according to specific instructions between two or more parties. The method involves one person (an initiator) transmitting a document set to a third party, along with a designated list of recipients and detailed document-processing instructions. These instructions define the state of final compliance. Optionally, the initiator may specify a protocol for notifying all parties of the outcome. Optionally, process start dates and decision dates the system used may include basic input and output peripherals, the Internet or other public computerized communication system and a trusted third party web site.

Accordingly, it is a principal object of the invention to provide a system and method for parties (including the general public) who wish to have the processing of document set handled by a trusted third party under strictly controlled conditions.

It is an object of the invention to provide a service for the asynchronous and virtually instantaneous transaction processing of documents where business transaction sequences may be ignored.

It is a further object of the invention is to provide trusted document processing to geographically separated parties who cannot meet for the purpose of face-to-face document processing or contract signing.

It is an object of the invention to provide improved elements and arrangements thereof in an apparatus for the purposes described which is inexpensive, dependable and fully effective in accomplishing its intended purposes.

It is an object of the invention to provide for automated processing, which would be both inexpensive and allow for the extremely fast conclusion of business transactions.

These and other objects of the present invention will become readily apparent upon further review of the following specification and drawings.

### BRIEF DESCRIPTION OF THE DRAWINGS

FIG. 1A is an overview of an enhanced document escrow method and system according to the present invention.

FIG. 1B is an overview of an enhanced escrow method according to the present invention.

FIG. 2 is a depicting of a transmitted document set and working title according to the present invention.

FIG. 3 is a depicting of identified designated recipients and their contact information according to the present invention.

FIG. 4 is a depicting of detailed document processing information according to the present invention.

FIG. 5 is a depicting of a process start date, decision date and whether an individual compliance report was provided, according to the present invention.

FIG. 6 is a depicting of an individual compliance report according to the present invention.

Similar reference characters denote corresponding features consistently throughout the attached drawings.

### DETAILED DESCRIPTION OF THE PREFERRED EMBODIMENT

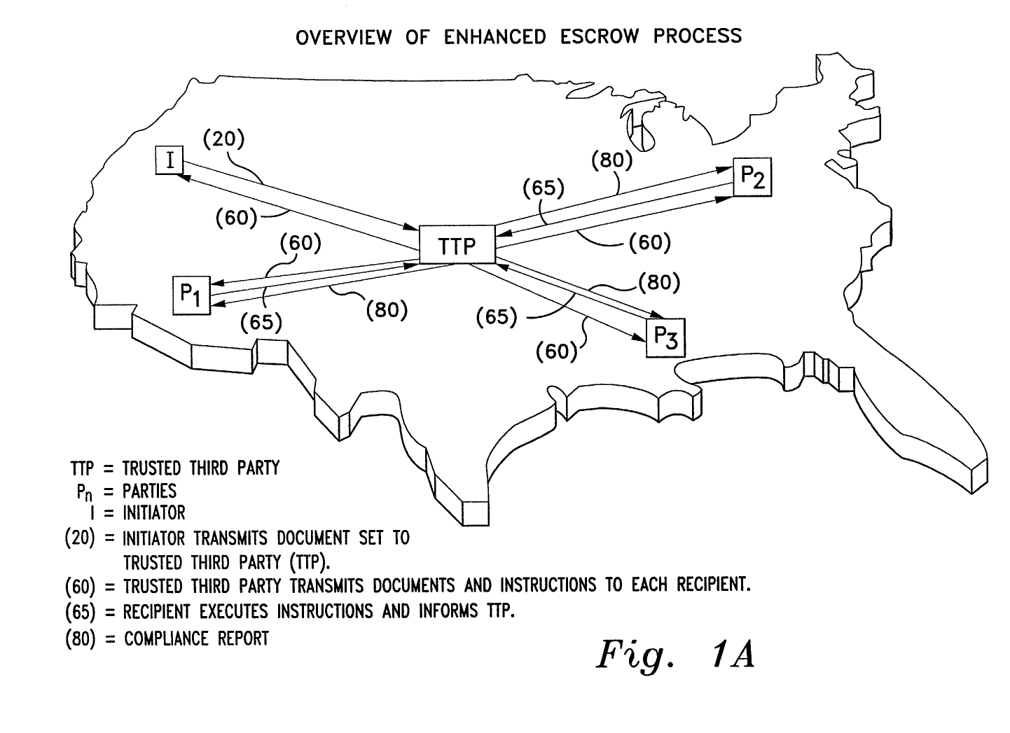

The present invention is a method for an enhanced document escrow service 10, with an overview of the overall method shown in FIG. 1A. The method may require the use of commonly used input and output devices, an escrow web site, as well as a communications medium, such as the Internet between the input and output devices of an initiator I, a trusted third party TTP and a designated recipient(s) or parties Pn. A document set and instruction is sent from the initiator I to the trusted third party TTP and eventually to each party Pn. This is utilized in the enhanced escrow method depicted in FIG. 1B.

The method for an enhanced document escrow service 10 comprises the steps of transmitting a document set from an initiator I to a trusted third party TTP 20, the initiator I identifying designated parties Pn that the document set eventually goes to 30, the initiator I providing detailed document-processing instructions 40, the initiator I optionally setting a process start date and a decision date 50, the trusted third party TTP transmitting the document set and the processing instructions to the designated parties 60, the parties Pn actually executing the processing instructions 65 and the trusted third party TTP determining a final state of instruction compliance 70 and distributing individual compliance reports 80.

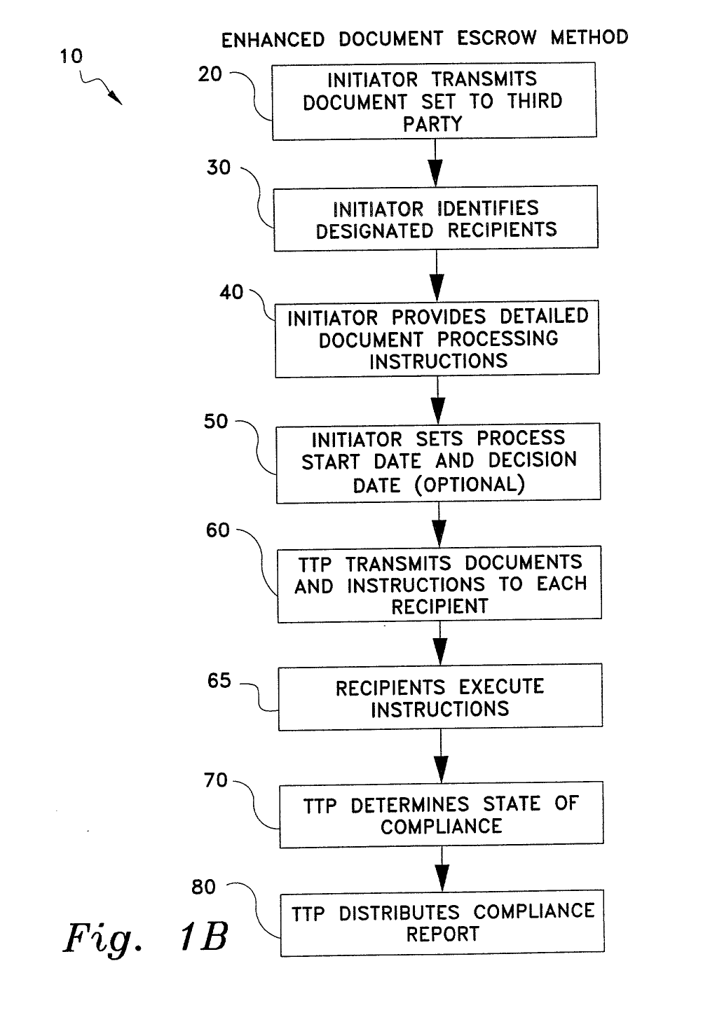

The first step of the overall method involves transmitting a document set 20. This is specifically done by the initiator I transmitting the document set to the trusted third party TTP with all of the processing instructions and party list. This is typically done by uploading the document set from the initiator I's input device to a remote server operated by the trusted third party TTP that is typically tied into a public communications media, such as the Internet, where a working title 21, a document number 22 and file name 23 for each document is provided. An illustration of this is shown in FIG. 2. “Uploading documents” from an input device (e.g. computer) to a Web site is well-known to those schooled in the art and is not a point of novelty with this invention.

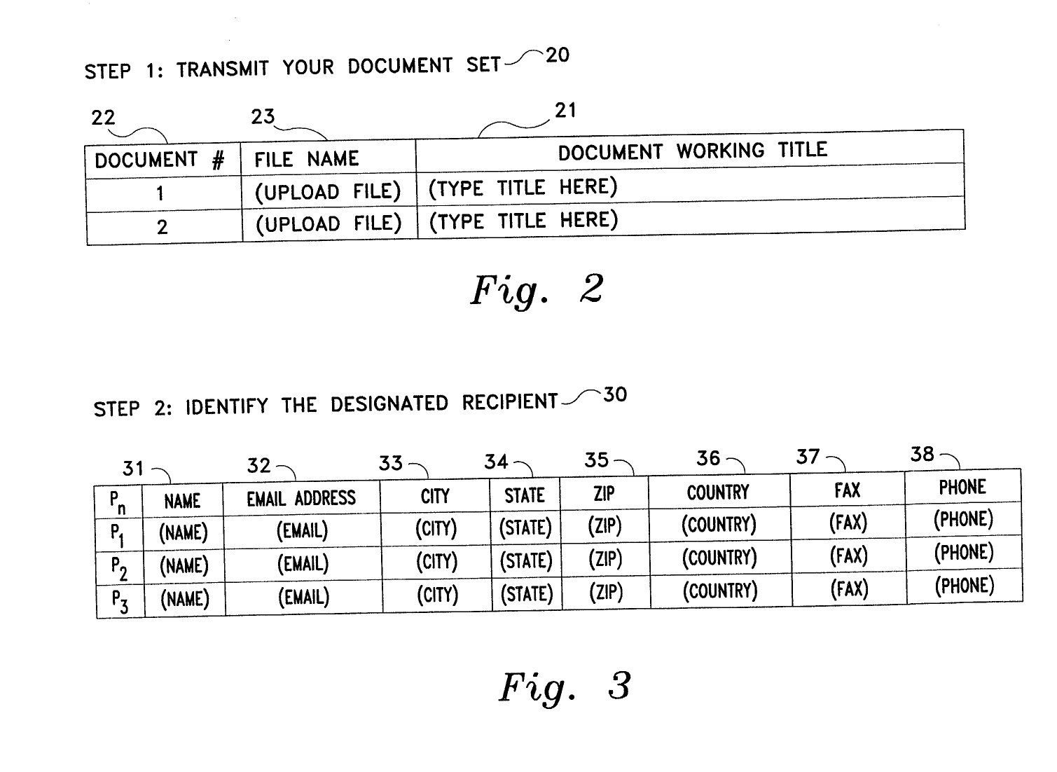

The document set is received from the initiator I at the trusted third party TTP's Web site with specific processing instructions for each eventual designated party Pn and a second set of processing instructions for the trusted third party TTP to follow at the conclusion of the enhanced escrow processing (that is, instructions for outcome notification). The next step of the overall method is to simply identify the designated parties 30. As shown in FIG. 3, this may include the name 31, e-mail address 32, clty 33, state 34, zip code 35, country 36, fax number 37 and telephone number 38 of each of the designated parties Pn who should receive the documents in the document set and the accompanying instructions.

The business process sequence or order of things can be ignored in the use of this method. Events can occur in any order, because the outcome of the process is not disclosed until the process is complete. So, for example, a real estate buyer could sign a purchase contract before a title search is done. That is allowed by this business method, as the final outcome of the purchase is not revealed until the process terminates in the manner specified by the initiator I. So, if the title search is acceptable (and all other process requirements are fulfilled), the purchase will go through. If the title search (or any other process requirement) is not fulfilled, then the purchase will not go through. Overall, this is similar to what parallel processing is in the computer science related art.

The next step of the overall method is to provide the detailed document-processing instructions 40 for each respective designated party Pn. This information can also be provided over the Internet and may require the designated parties Pn to have an input or output device to receive this information. Note that these document sets are also stored on a common storage media, such as a database or hard drive, provided by the trusted third party TTP.

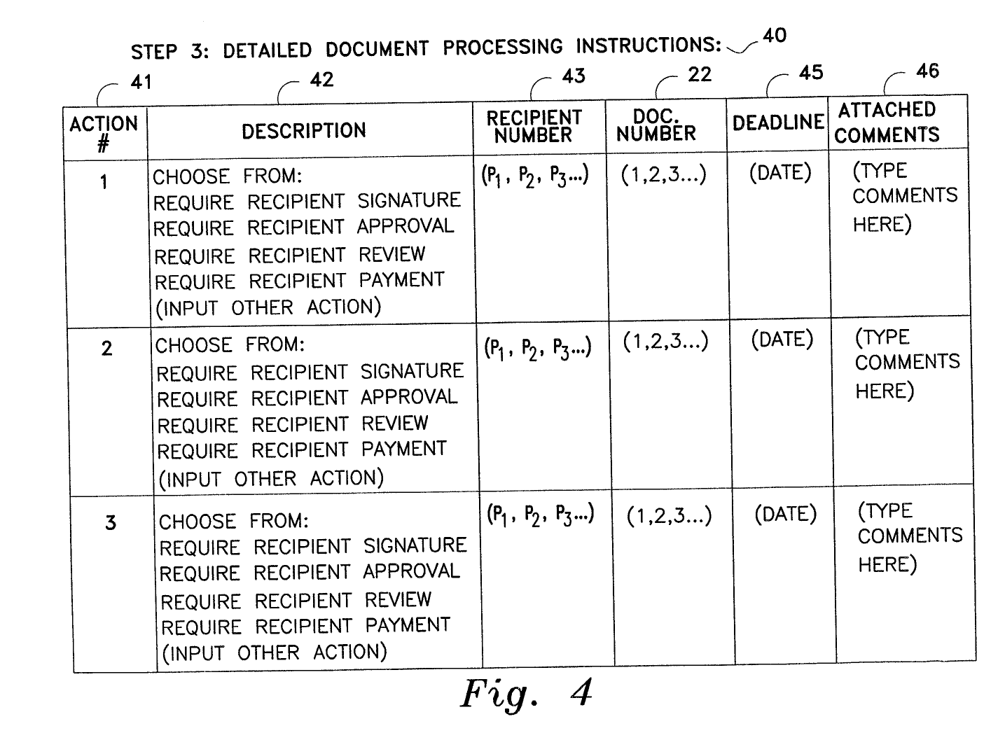

FIG. 4 shows an input page used by the initiator I to convey instructions to the trusted third party TTP. Each party Pn only receives the instructions destined for himself. The initiator I describes each action within the business process. For each action, he describes: the action itself 42, the party involved 43, the document involved 22, a deadline date 45 (optional) and any attached comments 46 (optional). Since most of the documents in a document set involve a party Pn signature, approval, review or payment, these are the chosen defaulted actions provided to the Initiator I. As indicated previously, specific instructions can still be given to a designated party Pn if needed. For purposes of personal identification, public keys could be used, and for the purposes of secure transmission, file encryption could be used.

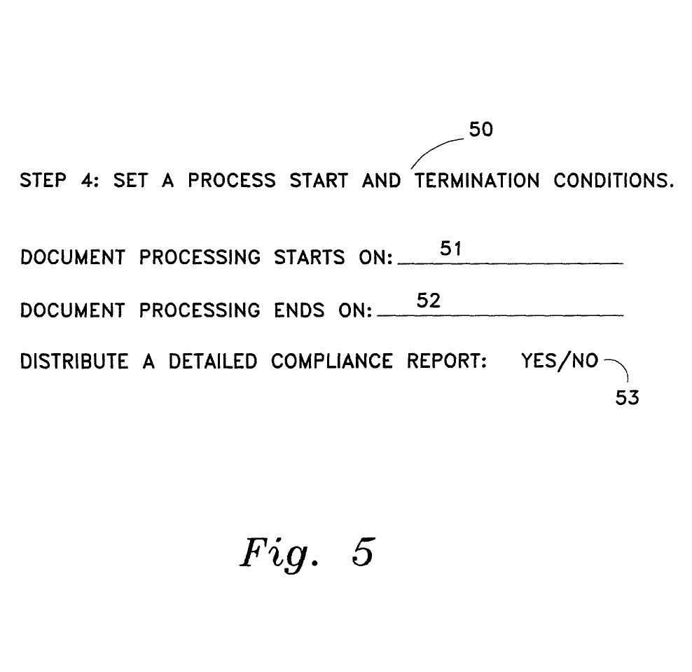

Processing will begin on the start date 51 that is specified in FIG. 5. A decision date 52 can also be established, which is the date that the level of compliance by the designated parties Pn is evaluated by the trusted third party TTP and established, and it is the date by which processing must be completed or be completely abandoned. Information as to whether or not a detailed compliance report is provided to participating parties Pn 53 is also indicated.

Processing may terminate under one of three conditions. These conditions include reaching a specific end date, reaching 100% compliance with the initiator's instructions or reaching an Initiator-specified termination condition. This last condition can be any condition that the Initiator cares to name, such as the stock market reaching a certain point. Thus, for example, the Initiator may specify that the processing shall end on May 1, 2003 or when the stock market reaches 20,000, whichever occurs first.

If all the designated parties Pn complied 100% with the document processing operation instructions provided to them, the trusted third party TTP may report “Success” as the result of the document processing operation 63. If there was less than 100% compliance with the instructions, the trusted third party TTP may report “Failure” as the result of the document processing operation.

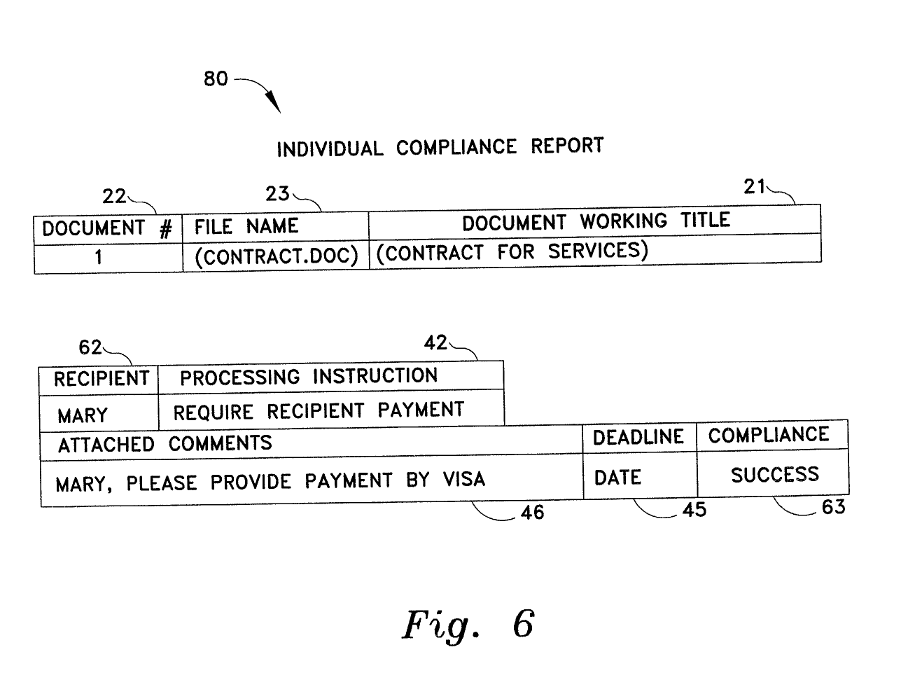

As can be seen in FIG. 6, the Individual Compliance Report is a summation of the individual instructions sent to each party Pn and whether or not there was compliance with the instructions. FIG. 6 information includes the document number 22, the file name 23, the document working title 21, the party's Pn name 62, processing instructions 42, Initiator's comments 46, deadline date 45 and state of compliance with instructions 63.

If the business process is a success, the overall method is terminated. If the business process is a failure, the process can be terminated or started all over again from the beginning of the method.

It is to be understood that the present invention is not limited to the sole embodiment described above, but encompasses any and all embodiments within the scope of the following claims.

I claim:

1. A method for a document escrow service, comprising the steps of:
transmitting a document set to a trusted third party;
identifying designated parties;
providing detailed document processing instructions;
setting a process start date and a decision date;
transmitting the document set and the processing instructions to the designated recipients; and
determining a state of instruction compliance.

2. The method according to claim 1, wherein transmitting the document set to the trusted third party further comprises the step of providing a working title and a document number for the document set.

3. The method according to claim 1, wherein identifying designated recipients further comprises the step of providing contact information such as an address, a fax number and a telephone number for each of the designated recipients.

4. The method according to claim 1, wherein providing detailed document processing instructions further comprises the steps of:
providing a list of involved parties;
choosing specific provided actions for each party; and
providing comments for each instruction.

5. The method according to claim 1, wherein determining a manner of termination comprises the step of setting a process end date and establishing that termination shall occur upon instruction compliance.

6. The method according to claim 1, wherein determining state of the instruction compliance further comprises the step of summarizing each instruction and compliance therewith.
